(19) United States
(12) Patent Application Publication
(10) Pub. No.: US 2012/0128285 A1
(43) Pub. Date: May 24, 2012

(54) SLIDING BEARING

(75) Inventors: Yukihiko Kagohara, Inuyama-shi (JP); Tomoyuki Nirasawa, Aichi (JP); Takeshi Hoshina, Aichi (JP)

(73) Assignee: DAIDO METAL COMPAMY LTD., Nagoya-shi ,Aichi (JP)

(21) Appl. No.: 13/387,880

(22) PCT Filed: Jul. 16, 2010
(86) PCT No.: PCT/JP2010/062073

§ 371 Date: Jan. 30, 2012

(30) Foreign Application Priority Data
Jul. 29, 2009 (JP) 2009-176413

(51) Int. Cl. F16C 33/12

(52) U.S. Cl. 384/276

(57) ABSTRACT

A slide bearing including a metal backing; an Al-based intermediate layer; and an Al-based bearing alloy layer is disclosed. The Al-based bearing alloy layer includes one or more types of intermetallic compounds containing Al and two or more other types of elements, the Al-based bearing alloy layer including 8 or more grains of intermetallic compounds per μm² having a grain diameter less than 0.5 μm. When the elements constituting the intermetallic compound are represented as X1, X2, . . . , Xn (n is a positive integer), a relative abundance of the elements satisfy X1≧X2≧ . . . ≧Xn. An abundance ratio X1/X2 of element X1 to element X2 ranges from 1 to 10. The Al-based bearing alloy layer has a Vickers hardness ranging from 50 to 80.

### TECHNICAL FIELD

The present invention relates to a slide bearing provided with a metal backing, an Al-based intermediate layer, and an Al-based bearing alloy layer.

### BACKGROUND

A slide bearing with Al-based bearing alloy layer provided on its inner surface is generally configured based on a bimetal in which the Al-based bearing alloy layer and the metal backing are bonded by an Al-based intermediate layer. The bimetal is further machined to produce the slide bearing.

Such slide bearing exhibits good initial conformability and outstanding fatigue resistance and wear resistance against high specific load. Thus, such slide bearing is applied to automobiles and high power engines for industrial machines in general.

However, recent improvements in engine performance require greater fatigue resistance against high specific load.

JP 2000-17363 A discloses one example of a slide bearing with improved fatigue resistance. The Al-based bearing alloy layer of the disclosed slide bearing comprises an Al—Sn—Si bearing alloy layer. The Al-based bearing alloy layer further contains additives of Cr and Zr. JP 2000-17363 A teaches that Cr and Zr additives to the Al-based bearing alloy layer causes precipitation of a binary intermetallic compound comprising Al—Cr in the Al crystal grain boundary of the Al-based bearing alloy layer as well as precipitation of a binary intermetallic compound comprising Al—Zr in the subgrain boundary within the Al crystal grain. JP 2000-17363 A further teaches that the precipitation of such intermetallic compounds facilitates the improvement of fatigue resistance of the slide bearing.

### SUMMARY OF THE INVENTION

### Problem to be Overcome

In attempt to design lighter engines, housings such as connecting rods accommodating the slide bearings are becoming more and more thinner. Housings are thinned at the expense of reduced strength and consequently become deformation prone. Housings are thus, easily deformed by forces such as the dynamic load of the counter shaft, typically a crankshaft, which is supported by the slide bearing, thereby rendering the slide bearing itself deformation prone. As a result, the slide bearing is subjected to repeated bending stress and rendered fatigue prone. Slide bearings being subjected to such repeated bending stress needs to be highly resistant to bending fatigue. While JP 2000-17363 A teaches an Al-based bearing alloy layer that is strong and flexible, it is susceptible to plastic deformation when subjected to repeated bending stress and fatigues prematurely.

When the slide bearing itself deforms by the deformation of the housing, a localized contact may occur between the slide bearing and the counter shaft. In such instances, a slide bearing with low conformability is subjected to seizures.

The present invention was conceived to address the above described problems and its objective is to provide a slide bearing that exhibits outstanding fatigue resistance against high specific load as well as excellent conformability.

### Means to Overcomer the Problem

In the Al-based bearing alloy layer taught in JP 2000-17363 A, precipitation of an Al—Cr intermetallic compound was observed at the grain boundary of the matrix as well as a precipitation of Al—Zr intermetallic compound observed at the subgrain boundary within the crystal grain, which strengthened the matrix and enhanced the fatigue resistance. However, diligent experiments by the inventors revealed that when the Al-based bearing alloy layer was subjected to repeated bending stress, intermetallic compounds of Al—Cr and Al—Zr are released from the matrix, thereby failing to sufficiently prevent the plastic deformation even in the presence of intermetallic compound and resulting in fatigue.

The inventors presumed that the release of Al—Cr and Al—Zr intermetallic compounds from the matrix was attributable to the weak bond between the intermetallic compounds and the matrix. The inventors further presumed that a strong bond would prevent the release of intermetallic compounds and improve the bending fatigue strength. Based on these presumptions, the inventors found that when two or more types of elements were added to the Al-based bearing alloy layer to form a multi-element intermetallic compound between Al and the two or more types of elements, the multi-element intermetallic compound formed a strong bond with the matrix to render the release of the compounds difficult. The inventors also found that crystal grains having a small diameter and being distributed at a certain density or more were needed to form a strong bond with the matrix and prevent plastic deformation.

The inventors further found that controlling the hardness of Al-based bearing alloy layer containing a multi-element intermetallic compound comprising Al and two or more types of metallic elements gives high fatigue resistance as well outstanding conformability to the Al-based bearing alloy layer.

A slide bearing according to claim 1 of the present invention comprises a metal backing, an Al-based intermediate layer, and an Al-based bearing alloy layer, the Al-based bearing alloy layer comprising one or more types of intermetallic compounds containing Al and two or more other types of elements, the Al-based bearing alloy layer including 8 or more grains of intermetallic compounds per μm² having a grain diameter less than 0.5 μm, and when the elements constituting the intermetallic compound are represented as X1, X2, . . . , Xn (n is a positive integer), a relative abundance of the elements satisfy X1≧X2≧ . . . ≧Xn, and an abundance ratio X1/X2 of element X1 to element X2 ranges from 1 to 10, and the Al-based bearing alloy layer has a Vickers hardness ranging from 50 to 80.

Elements X1, X2, . . . , Xn do not include Al. The relative abundance is used in the present invention to indicate the mass ratio of each of the elements X1, X2, . . . , Xn within each intermetallic compound. In case of producing two or more types of intermetallic compounds, a first intermetallic compound comprises elements X1(1), X2(1), . . . , Xn(1), where the relative abundance of the elements satisfy X1(1)≧X2(1)≧ . . . ≧Xn(1), an abundance ratio X1(1)/X2(1) of element X1(1) to element X2(1) ranges from 1 to 10; and a second intermetallic compound comprises elements X1(2), X2(2), . . . , Xn(2), where the relative abundance of the elements satisfy X1(2)≧X2(2)≧ . . . ≧Xn(2), an abundance ratio X1(2)/X2(2) of element X1(2) to element X2(2) ranges from 1 to 10. That is, in case of producing m (m is a positive integer) types of intermetallic compounds, the mth intermetallic compound comprises elements X1(m), X2(m), . . . , Xn(m), where the relative abundance of the elements satisfy X1(m)≧X2(m)≧ . . . ≧Xn(m), and an abundance ratio X1(m)/X2(m) of element X1(m) to element X2(m) ranges from 1 to 10. The elements may be selected such that X1(1) and X1(m) are the same or different. However, X1(1) and Xn(1), for example, are different elements. Notations such as (m) may be omitted hereinafter.

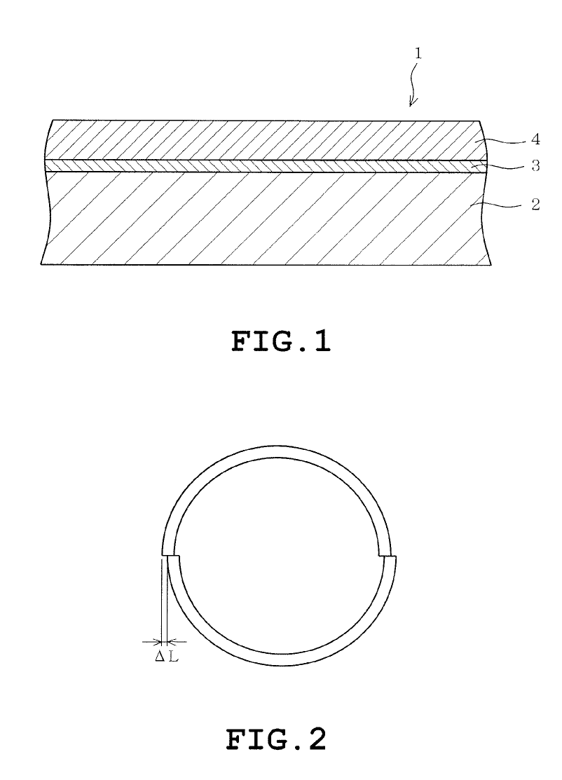

The basic configuration of a slide bearing of the present invention is illustrated in FIG. 1. Slide bearing 1 shown in FIG. 1 comprises a triple layer structure including metal backing 2 made of, for instance, steel and Al-based bearing alloy layer 4 bonded to metal backing 2 by way of Al-based intermediate layer 3.

According to the present invention, two or more types of elements are added to the Al-based bearing alloy layer to formulate a multi-element intermetallic compound with Al and to be incorporated by solid solution into the Al matrix. Because the matrix contains two or more types of component elements of the multi-element intermetallic compounds other than Al, the multi-element intermetallic compound strengthens its bond with the matrix. Thus, even if the slide bearing is subjected to repeated bending stress, multi-element intermetallic compound is not easily released from the matrix, thereby rendering plastic deformation of Al-based bearing alloy layer difficult and improving the bending fatigue strength of the slide bearing.

Examples of elements that bond with Al to form an intermetallic compound are metallic elements such as Mn, Cr, Ni, V, Zr, Ti, Mo, Fe, Co, W, and Si. For instance, when Mn and V are selected from the metallic elements, these elements formulate a multi-element intermetallic compound of Al—Mn—V, which may also be described a ternary intermetallic compound, as well as allowing solid solution of Mn and V into the matrix. In case Cr, Si, and Fe are selected, these elements formulate a multi-element intermetallic compound of Al—Cr (X1(1))-Si(X2(1))-Fe(X3(1)) which may also be described a quaternary intermetallic compound, as well as allowing solid solution of Cr, Si, and Fe into the matrix. Ternary intermetallic compounds such as Al—Cr (X1(2))-Si(X2(2)), Al—Cr (X1(3))-Fe(X2(3)), and Al—Si (X1(4))-Fe(X2(4)) may also be formulated. In case the mass ratios of Cr, Si, and Fe are equal, any one of Cr, Si, and Fe may be identified as X1(1), X2(1), and X3(1). The same is applicable when Ni, Zr, Ti, and Mo or other combinations are selected.

By controlling the abundance ratio X1/X2 of element X1 to element X2 formulating the intermetallic compound to range from 1 to 10 when the relative abundance of the elements are X1≧X2≧ . . . ≧Xn, a strong bond between the multi-element intermetallic compound and the matrix can be established reliably. The abundance ratio X1/X2 is preferably 8 or less. The plastic deformation is effectively prevented when the multi-element intermetallic compound is smaller than 0.5 μm and is distributed in the density of 8 or more grains per 1 μm². Multi-element intermetallic compound controlled in this range can be strengthened without losing the elongation of the matrix. The distribution density preferably ranges from 15 to 70 grains per 1 μm².

Further, the hardness of the Al-based bearing alloy layer can be modified by varying its composition, for instance, by varying the compositional ratio of the multi-element intermetallic compound. By controlling the hardness of the Al-based bearing alloy layer to 50 or more in Vickers hardness, the Al-based bearing alloy layer will not easily fatigue even when subjected to heavy load in high power engine applications. Further, controlling the Vickers hardness at 80 or less will give good conformability to the Al-based bearing alloy layer. It is preferable to control the Vickers hardness of the Al-based bearing alloy layer to range from 60 to 70 in view of fatigue resistance and conformability.

The slide bearing configured as described above obtains outstanding fatigue resistance and conformability as well when subjected to high specific load.

The slide bearing of the present invention is manufactured through a casting step, rolling step, roll bonding step, heat treatment (annealing) step, and a machining step. More specifically, casting step melts the Al-based bearing alloy (later becoming the Al-based bearing alloy layer) and casts it into a sheet. The cast sheet of Al-based bearing alloy is rolled in the rolling step and thereafter bonded together with a steel sheet (metal backing) over a thin sheet of Al-based alloy (Al-based intermediate layer) in the roll bonding step to obtain a bearing forming sheet. Then the bearing forming sheet is annealed and finally machined into a semi-cylindrical or a cylindrical bearing. The above described manufacturing steps allow a small intermetallic compound less than 0.5 μm in diameter to be precipitated through the process of rolling a cast Al-based bearing alloy and annealing the bearing forming sheet.

The term grain diameter is used herein to denote the maximum length per crystal of intermetallic compound obtained through an electron microscope analysis.

A slide bearing according to claim 2 of the present invention comprises an Al-based intermediate layer having a hardness ranging from 70% to 90% of the hardness of the Al-based bearing alloy layer.

By controlling the hardness of the Al-based intermediate layer to be 70% or more of the hardness of the Al-based bearing alloy layer, heavy load received through the Al-based bearing alloy layer can be resisted more reliably while preventing the Al-based intermediate layer from sticking out of the width-directional edge of the slide bearing to improve the fatigue resistance of the slide bearing in general. Further, by controlling the hardness of the Al-based intermediate layer to be 90% or less of the hardness of the Al-based bearing alloy layer, the Al-based intermediate layer may serve as a cushion to absorb the variation in the load applied to the Al-based bearing alloy layer and further improve the conformability of the Al-based bearing alloy layer.

According to the slide bearing of claim 3 of the present invention, the Al-based intermediate layer and the Al-based bearing alloy layer contain Fe, and the Fe content in the Al-based intermediate layer ranges from 0.5 mass % to 1.5 mass % and more than twice the Fe content in the Al-based bearing alloy layer.

By giving controlled amount of Fe content in the Al-based intermediate layer and the Al-based bearing alloy layer, heat resistance of the Al-based intermediate layer and the Al-based bearing alloy layer is improved. Thus, strengths of the Al-based intermediate layer and the Al-based bearing alloy layer can be maintained even at high temperatures which is the environment in which a slide bearing is actually used. Giving controlled amount of Fe content in the Al-based intermediate layer and the Al-based bearing alloy layer further renders the Al-based intermediate layer and the Al-based bearing alloy layer difficult to work harden. As a result, the Al-based bearing alloy layer is improved in conformability to inhibit accumulation of metallic fatigue in the Al-based intermediate layer and the Al-based bearing alloy layer.

By controlling the Fe content in the Al-based intermediate layer to 0.5 mass % or more, heat resistance as well as fatigue resistance can be improved. Controlling the Fe content in the Al-based intermediate layer to 1.5 mass % or less facilitates the control of Vickers hardness of the Al-based intermediate layer to 75 or less, thereby further improving conformability.

Sliding heat occurring at the surface of the Al-based bearing alloy layer by the sliding contact between the counter member and the Al-based bearing alloy layer is transmitted toward the metal backing from the surface of the Al-based bearing alloy layer. Thus, a slide bearing with the hardness of its Al-based intermediate layer controlled to range from 70% to 90% of the hardness of the Al-based bearing alloy layer may lack in the strength of Al-based intermediate layer in particular when the temperature of the Al-based intermediate layer is elevated by the sliding heat. Hence, the present invention is configured to control the Fe content within Al-based intermediate layer to be more than twice the Fe content in the Al-based bearing alloy layer. As a result, the Al-based intermediate layer is rendered difficult to soften even when subjected to high temperature, thereby maintaining the strength of the Al-based intermediate layer.

According to the slide bearing of claim 4 of the present invention, the Al-based bearing alloy layer contains a Si grain having a grain diameter greater than 0.5 μm.

By giving Si grains having a grain diameter greater than 0.5 μm into the Al-based bearing alloy layer, the counter shaft may be lapped by the Si grains. Thus, seizure resistance of the slide bearing is improved. Though Si may also form an intermetallic compound, it is generally incorporated by solid solution into the matrix or crystallizes as a hard Si grain. Accordingly, the Al-based bearing alloy layer can be strengthened by giving Si into the Al-based bearing alloy layer. As a result, the fatigue resistance of the slide bearing is improved.

According to the slide bearing of claim 5 of the present invention, the Al-based bearing alloy layer comprises 3 to 20 mass % of Sn; 1.5 to 8 mass % of Si; at least one or more types of metallic elements selected from the group of Cu, Zn, and Mg, a total amount of which ranges from 0.1 to 7 mass %; and elements X1, X2, . . . , Xn (n is a positive integer) formulating an intermetallic compound with Al; and a balance of Al and unavoidable impurities, and the element X1 is selected from the group of Mn, Cr, Ni, V, Zr, and Si, and when selected from Mn, Cr, Ni, V, and Zr, a total amount thereof ranges from 0.01 to 2 mass %, and the element X2 being different from the element X1 is selected from the group of V, Ti, Zr, Mo, Fe, Co, W, Mn, and Si, and when selected from V, Ti, Zr, Mo, Fe, Co, W, and Mn, a total amount thereof ranges from 0.01 to 2 mass %. The above described quantities indicate the mass % within the Al-based bearing alloy layer.

Giving 3 mass % or more of Sn in the Al-based bearing alloy layer provides good conformability, seizure resistance, and embeddability to the slide bearing, and controlling the Sn content in the Al-based bearing alloy layer to 20 mass % or less provides good fatigue resistance.

Giving 1.5 mass % or more of Si in the Al-based bearing alloy layer sufficiently exerts the foregoing advantages of Si, and controlling the Si content to 8 mass % or less provides good fatigue resistance. It is preferable to control the Si content to more than 2 mass % to exert the advantages of the Si grain even more efficiently.

Cu, Zn, and Mg elements are incorporated into the matrix by solid solution. This allows strengthening of the matrix. Further, by controlling the total amount of one or more types of element selected from the group of Cu, Zn, and Mg to 0.1 mass % or more, the foregoing operations can be exerted sufficiently, and controlling the total amount to 7 mass % or less provides good conformability.

When element X1 is selected from the group of Mn, Cr, Ni, V, Zr, and Si, and element X2 being different from element X1 and is selected from the group of V, Ti, Zr, Mo, Fe, Co, W, Mn, and Si, elements X1 and X2 form a bond with Al to formulate one or more types of intermetallic compounds made of three elements (or more than three elements). By controlling the amount of element X1 when selected from Mn, Cr, Ni, V, and Zr, and the amount of element X2 when selected from V, Ti, Zr, Mo, Fe, Co, W, and Mn to 0.01 mass % or more, relatively greater amount of the above described intermetallic compound can be formulated, and by controlling the same to 2 mass % or less, good fatigue resistance can be obtained. Adjustments may be made to the parameters of anneal such as temperature and duration to control the amount of Si formulating the intermetallic compound as element X1, the amount of Si incorporated by solid solution, and the amount of Si crystallized as Si grains.

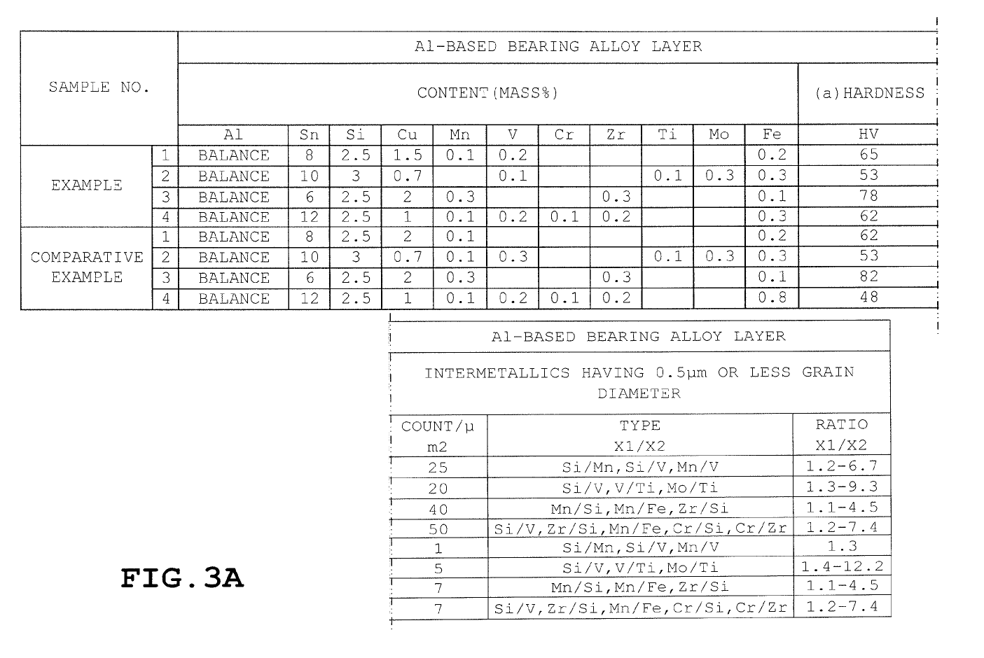

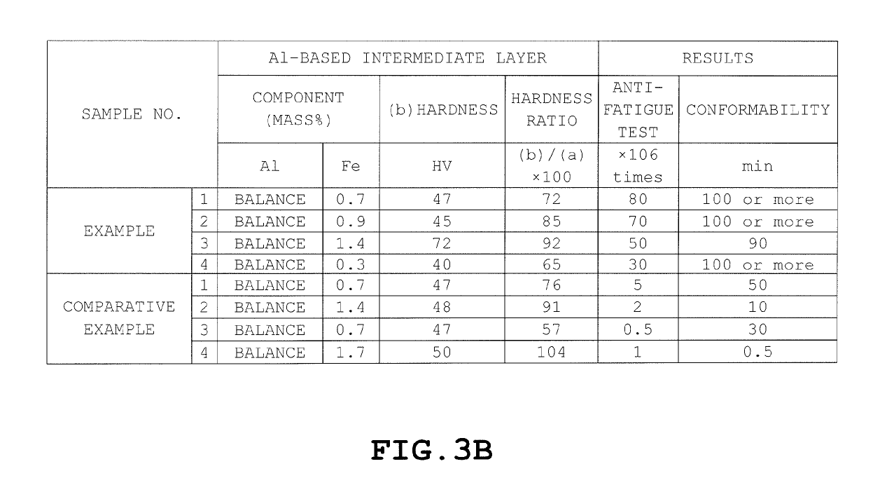

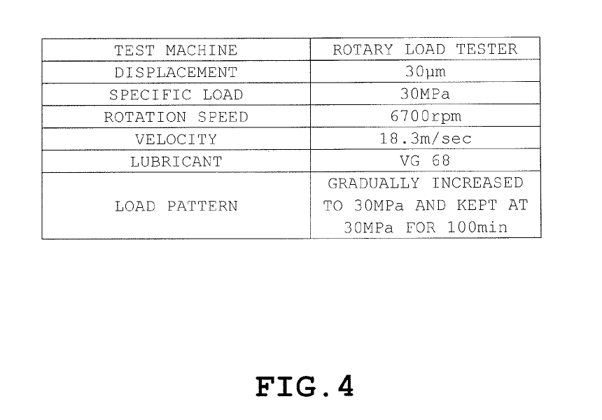

### BRIEF DESCRIPTION OF THE DRAWINGS

[FIG. 1] A cross sectional view of a slide bearing.

[FIG. 2] An illustration of a half bearing being attached to a test machine for conformability testing.

[FIGS. 3A and 3B] A chart indicating the compositions of the Al-based bearing alloy layer and the Al-based intermediate layer.

[FIG. 4] A chart indicating the test conditions.

### EMBODIMENTS OF THE INVENTION

To verify the effect of the present invention, samples of slide bearings (EXAMPLES 1 to 4) of the present invention were made using an Al-based bearing alloy layer and Al-based intermediate layer configured by compositions indicated in the chart indicated in FIGS. 3A and 3B as well as samples of slide bearings (COMPARATIVE EXAMPLES 1 to 4) employing a conventional configuration to conduct fatigue resistance test (bending fatigue strength test) and conformability test.

A method of manufacturing EXAMPLES 1 to 4 is as set forth below. First, a sheet of Al-based bearing alloy configured by a composition shown in the chart of FIGS. 3A and 3B was obtained, for instance, by a belt casting apparatus having outstanding mass productivity. Then, a thin sheet constituting the Al-based intermediate layer configured by a composition shown in the chart of FIGS. 3A and 3B was bonded against the cast Al-based bearing alloy to obtain a sheet of multi-layered aluminum alloy, and the sheet of multi-layered aluminum alloy was bonded against a steel sheet constituting the metal backing to obtain the bearing forming sheet (i.e. bimetal). Then, the bearing forming sheet was annealed for 1 to 10 hours in a temperature above 350 degrees and equal to or less than 450 degrees controlled as required depending upon the composition.

Annealing of the bearing forming sheet causes the precipitation of intermetallic compounds within the matrix of the Al-based bearing alloy layer. Electron microscope analysis on the size of the precipitated intermetallic compound based on the photographic images of the microstructure found that grains of intermetallic compounds having a grain diameter less than 0.5 μm was present in the count indicated in the chart of FIGS. 3A and 3B per 1 μm².

The method of manufacturing COMPARATIVE EXAMPLES 1 to 4, on the other hand, differs from the method of manufacturing the above described EXAMPLES 1 to 4 in that the bearing forming sheet was annealed at the conventional temperature ranging from 300° C. to 350° C.

The abundance of intermetallic compounds within the Al-based bearing alloy layer thus obtained was very little as shown the chart of FIGS. 3A and 3B.

The above described EXAMPLES 1 to 4 and COMPARATIVE EXAMPLES 1 to 4 were tested for their fatigue resistance (bending fatigue strength) and conformability as set forth below.

### (1) Fatigue Resistance Test (Bending Fatigue Strength Test)

The annealed bearing forming sheet was machined to obtain pieces of samples (EXAMPLES 1 to 4, COMPARATIVE EXAMPLES 1 to 4) which were subjected to a bending fatigue strength test for verifying their fatigue resistance. The pieces of samples each amount to a thickness of 1.5 mm with the metal backing being 1.2 mm thick and the Al-based bearing alloy layer and the Al-based intermediate layer taken together being 0.3 mm thick. The test was conducted by repeatedly bending the samples reciprocally such that the surface of the Al-based bearing alloy layer exhibited a constant level of bend until a crack was formed on the surface of the Al-based bearing alloy layer. The repeated count of reciprocal bending until the crack formation was observed on the surface of the Al-based bearing alloy layer of the samples of the fatigue resistance testing (bending fatigue strength test) is indicated in the chart of FIGS. 3A and 3B.

### (2) Conformability Test

The annealed bearing forming sheet was machined to obtain slide bearings identified as EXAMPLES 1 to 4, COMPARATIVE EXAMPLES 1 to 4 which were subjected to a conformability test for verifying their conformability. The conformability test was conducted by mating two pieces of samples formed into a half bearing as shown in FIG. 2 such that the pieces are diametrically displaced by ΔL, which, in this test, is set at 30 μm, and the samples were mounted on the rotary load tester in this state to conduct the conformability test under the conditions indicated in the chart of FIG. 4. The test is conduced by applying rotational load on the inner circumferential surface of the slide bearing by the centrifugal force of a shaft using a rotary load tester.

By mounting the displaced slide bearing, conformability of the slide bearing can be verified through the load of the shaft being applied on the circumferential ends of the slide bearing. Good conformability verified in this test will ensure that affects of localized contact is avoided effectively and that seizures and fatigue-induced damages are prevented for an extensive time period. The load is gradually increased to the test load of 30 MPa and the time taken to damage the slide bearing after reaching the test load was measured.

In the chart of FIGS. 3A and 3B, with the assumption that the intermetallic compound comprises multiple elements including Al, “TYPE X1/X2” indicates the two types of elements (element X1 and element X2) having the greatest relative abundance within the intermetallic compound excluding Al. In the presence of multiple types of intermetallic compounds, multiple entries of “TYPE X1/X2” are given.

The notation of “Ratio X1/X2” indicates the abundance ratio X1/X2 which is the quotient of element X1 divided by element X2 when element X1 and element X2 are represented by their mass ratios within the intermetallic compound.

The notation of “Hardness Ratio” indicates a percentage representation of the quotient given by dividing the Vickers hardness obtained for the Al-based intermediate layer (b) by the Vickers hardness obtained for the Al-based bearing alloy layer (a).

Next, an analysis will be given on the test results.

It can be understood from verifying the results of the fatigue resistance test that EXAMPLES 1 to 4 exhibit outstanding fatigue resistance by maintaining excellent bending fatigue strength for an extensive period of time as compared to COMPARATIVE EXAMPLES 1 to 4.

It can be understood from the comparison of EXAMPLES 1 to 4 with COMPARATIVE EXAMPLES 1 to 4 that when abundance ratio X1/X2 ranges from 1 to 10, and 8 or more grains of intermetallic compounds having a grain diameter less than 0.5 μm is present per 1 μm², these intermetallic compounds inhibit the transfer of dislocation within the matrix to improve the bending fatigue strength, and controlling the Vickers hardness of the Al-based bearing alloy layer to 50 or more gave exceptionally outstanding fatigue resistance.

It can be understood from the comparison of EXAMPLES 1 to 3 with EXAMPLE 4 that because the Fe content within the Al-based intermediate layer is more than twice the Fe content of the Al-based bearing alloy layer in EXAMPLES 1 to 3, the Al-based intermediate layer is not easily softened even when heat is generated in the Al-based intermediate layer by the repeated reciprocal bending, thereby obtaining an exceptionally good fatigue resistance.

It can be understood from verifying the results of the conformability test that because the Vickers hardness of the Al-based bearing alloy layer is controlled to 80 or less, localized contact between the counter member and the samples are avoided effectively, thereby obtaining good conformability. EXAMPLES 1 to 4 configured as described above showed high resistance to fatigue while possessing good conformability.

It can be understood from comparison of EXAMPLES 1, 2, and 4 with EXAMPLE 3 that EXAMPLES 1, 2, and 4 exhibit exceptionally outstanding conformability because the hardness the Al-based intermediate layer is controlled to 90% or less of the hardness of the Al-based bearing alloy layer.

Modified embodiments are considered to fall within the scope of the invention so long as they do not deviate from the inventive concept.

1. A slide bearing comprising:
a metal backing;
an Al-based intermediate layer; and
an Al-based bearing alloy layer,
wherein the Al-based bearing alloy layer comprises one or more types of intermetallic compounds containing Al and two or more other types of elements, the Al-based bearing alloy layer including 8 or more grains of intermetallic compounds per μm² having a grain diameter less than 0.5 μm, and
wherein when the elements constituting the intermetallic compound are represented as X1, X2, . . . , Xn (n is a positive integer), a relative abundance of the elements satisfy X1≧X2≧ . . . ≧Xn, and an abundance ratio X1/X2 of element X1 to element X2 ranges from 1 to 10, and
wherein the Al-based bearing alloy layer has a Vickers hardness ranging from 50 to 80.

2. The slide bearing according to claim 1, wherein the Al-based intermediate layer has a hardness ranging from 70% to 90% of the hardness of the Al-based bearing alloy layer.

3. The slide bearing according to claim 1, wherein the Al-based intermediate layer and the Al-based bearing alloy layer contain Fe, the Fe content in the Al-based intermediate layer ranges from 0.5 mass % to 1.5 mass % and more than twice the Fe content in the Al-based bearing alloy layer.

4. The slide bearing according to claim 1, wherein the Al-based bearing alloy layer contains a Si grain having a grain diameter greater than 0.5 μm.

5. The slide bearing according to claim 1, wherein the Al-based bearing alloy layer further comprises:
3 to 20 mass % of Sn;
1.5 to 8 mass % of Si;
at least one or more types of metallic elements selected from the group of Cu, Zn, and Mg, a total amount of which ranges from 0.1 to 7 mass %; and
elements X1, X2, . . . , Xn (n is a positive integer) formulating an intermetallic compound with Al; and
a balance of Al and unavoidable impurities, and
wherein the element X1 is selected from the group of Mn, Cr, Ni, V, Zr, and Si, and when selected from Mn, Cr, Ni, V, and Zr, a total amount thereof ranges from 0.01 to 2 mass %, and
wherein the element X2 being different from the element X1 is selected from the group of V, Ti, Zr, Mo, Fe, Co, W, Mn, and Si, and when selected from V, Ti, Zr, Mo, Fe, Co, W, and Mn, a total amount thereof ranges from 0.01 to 2 mass %.

6. The slide bearing according to claim 2, wherein the Al-based intermediate layer
and the Al-based bearing alloy layer contain Fe, the Fe content in the Al-based intermediate layer ranges from 0.5 mass % to 1.5 mass % and more than twice the Fe content in the Al-based bearing alloy layer.

7. The slide bearing according to claim 2, wherein the Al-based bearing alloy layer contains a Si grain having a grain diameter greater than 0.5 μm.

8. The slide bearing according to claim 3, wherein the Al-based bearing alloy layer contains a Si grain having a grain diameter greater than 0.5 μm.

9. The slide bearing according to claim 2, wherein the Al-based bearing alloy layer further comprises:
3 to 20 mass % of Sn;
1.5 to 8 mass % of Si;
at least one or more types of metallic elements selected from the group of Cu, Zn, and Mg, a total amount of which ranges from 0.1 to 7 mass %; and
elements X1, X2, . . . , Xn (n is a positive integer) formulating an intermetallic compound with Al; and
a balance of Al and unavoidable impurities, and
wherein the element X1 is selected from the group of Mn, Cr, Ni, V, Zr, and Si, and when selected from Mn, Cr, Ni, V, and Zr, a total amount thereof ranges from 0.01 to 2 mass %, and
wherein the element X2 being different from the element X1 is selected from the group of V, Ti, Zr, Mo, Fe, Co, W, Mn, and Si, and when selected from V, Ti, Zr, Mo, Fe, Co, W, and Mn, a total amount thereof ranges from 0.01 to 2 mass %.

10. The slide bearing according to claim 3, wherein the Al-based bearing alloy layer further comprises:
3 to 20 mass % of Sn;
1.5 to 8 mass % of Si;
at least one or more types of metallic elements selected from the group of Cu, Zn, and Mg, a total amount of which ranges from 0.1 to 7 mass %; and
elements X1, X2, . . . , Xn (n is a positive integer) formulating an intermetallic compound with Al; and
a balance of Al and unavoidable impurities, and
wherein the element X1 is selected from the group of Mn, Cr, Ni, V, Zr, and Si, and when selected from Mn, Cr, Ni, V, and Zr, a total amount thereof ranges from 0.01 to 2 mass %, and
wherein the element X2 being different from the element X1 is selected from the group of V, Ti, Zr, Mo, Fe, Co, W, Mn, and Si, and when selected from V, Ti, Zr, Mo, Fe, Co, W, and Mn, a total amount thereof ranges from 0.01 to 2 mass %.

11. The slide bearing according to claim 4, wherein the Al-based bearing alloy layer further comprises:
3 to 20 mass % of Sn;
1.5 to 8 mass % of Si;
at least one or more types of metallic elements selected from the group of Cu, Zn, and Mg, a total amount of which ranges from 0.1 to 7 mass %; and
elements X1, X2, . . . , Xn (n is a positive integer) formulating an intermetallic compound with Al; and
a balance of Al and unavoidable impurities, and
wherein the element X1 is selected from the group of Mn, Cr, Ni, V, Zr, and Si, and when selected from Mn, Cr, Ni, V, and Zr, a total amount thereof ranges from 0.01 to 2 mass %, and
wherein the element X2 being different from the element X1 is selected from the group of V, Ti, Zr, Mo, Fe, Co, W, Mn, and Si, and when selected from V, Ti, Zr, Mo, Fe, Co, W, and Mn, a total amount thereof ranges from 0.01 to 2 mass %.
